(19) United States
(12) Patent Application Publication
(10) Pub. No.: US 2016/0036658 A1
(43) Pub. Date: Feb. 4, 2016

(54) METHOD FOR TESTING A MOBILITY DEVICE

(71) Applicant: Caterpillar Inc., Peoria, IL (US)

(72) Inventor: Ruban C. Kumar, Chennai (IN)

(73) Assignee: Caterpillar Inc., Peoria, IL (US)

(21) Appl. No.: 14/879,100

(22) Filed: Oct. 9, 2015

(51) Int. Cl. H04L 12/26; H04L 29/06

(52) U.S. Cl. CPC H04L 43/04; H04L 69/16

(57) ABSTRACT

A method for performing a real time testing of a mobility device located at a remote location using a test framework communicatively coupled with the mobility device by means of either a TCP/IP protocol or a UDP protocol, and configured to execute a client application is provided. A server application receives a remote command is received from the client application, for retrieving a test information. The test information is generated by communicating with an operating system of the mobility device, in response to the remote command. The test information includes information related to the operating system, the server application, and screenshot of a region of interest area on a display unit of the mobility device. The test information is compressed using a custom compressor, and is sent to the client application. Further, tests are performed by a test system based on the received test information from the test framework.

### TECHNICAL FIELD

The present disclosure relates to testing of mobility devices, and more specifically, to an automated test framework for testing mobility devices.

### BACKGROUND

Testing of devices such as electronic devices, and electromechanical devices having a plurality of sophisticated subsystems is well known. A device that is physically located within or near a service station can be physically tested as well as directly connected to a test system by means of plug-in cables for testing. In certain situations, mobile sites are created such that a device to be tested is required to be in close proximity of the mobile site for transferring test data. Moreover, the device to be tested is usually stopped from performing its usual functions, and is required to be involved in the testing process only.

Devices that are on the move and are located in remote geographic locations can neither access a service station nor a mobile site, and therefore, cannot be connected to the test system for providing real time test information. Moreover, the test system requires test information from multiple sources for conducting a test, this process of compiling and analyzing test information can be time consuming and may introduce errors into the testing and reporting procedure. Testing a device is also dependent on an operating system of the device such that for a particular operating system, a particular test system is needed. This further complicates testing due to non-interoperability of the test system for different devices having different operating systems.

United States Publication Number 2014/0354321 discloses a system that includes an Electronic Control Module (ECM) connector that can be connected to one or more electronic control modules of the device. The ECM connector has either a male connector or a female connector. Similarly, a testing unit (TU) includes at least one TU connector connectable with the testing unit. Further, an actuator is connectable to the ECM connector and the TU connector. The actuator is configured to facilitate an electrical connection between the ECM and the testing unit in response to a relay signal generated by the testing unit. The system disclosed by the reference requires the device to be physically connected to the testing unit, therefore, it is not applicable to devices that are remotely located. Hence, there exists a need for effective and efficient automated testing of a mobility device located at a remote geographic location in real time and to integrate it with a test system.

### SUMMARY OF THE DISCLOSURE

In one aspect of the present disclosure, a method for performing a real time testing of a mobility device located at a remote location using a test framework communicatively coupled with the mobility device by means of either a TCP/IP protocol or a User Datagram Protocol (UDP) protocol, and configured to execute a client application is provided. A remote command is received from the client application, by a server application running on the mobility device, for retrieving a test information. The remote command is received over either the TCP/IP protocol or the UDP protocol. The test information is generated, by the server application, by communicating with an operating system of the mobility device, in response to the received remote command. The test information includes one or more of information related to the operating system, information related to the server application, and screenshot of a region of interest area on a display unit of the mobility device. The test information is compressed using a custom compressor running on the mobility device. The compressed test information is sent to the client application by the server application. The compressed test information is sent over either the TCP/IP protocol or the UDP protocol. Further, one or more tests are performed by a test system based on the test information. The test system is configured to receive the test information from the test framework.

Other features and aspects of this disclosure will be apparent from the following description and the accompanying drawings.

### BRIEF DESCRIPTION OF THE DRAWINGS

FIG. 1 is a block diagram illustrating a system for testing mobility devices, in accordance with the present disclosure;

FIG. 2 is a schematic diagram illustrating the system for performing real time testing of a mobility device located at a remote location, in accordance with the present disclosure;

FIG. 3 is a flowchart illustrating a method for performing real time testing of the mobility device located at the remote location, in accordance with the present disclosure; and

FIG. 4 is a detailed flowchart illustrating a method for performing real time testing of the mobility device located at the remote location using a test framework communicatively coupled with the mobility device by means of either a TCP/IP protocol or a UDP protocol, in accordance with an embodiment of the present disclosure.

### DETAILED DESCRIPTION

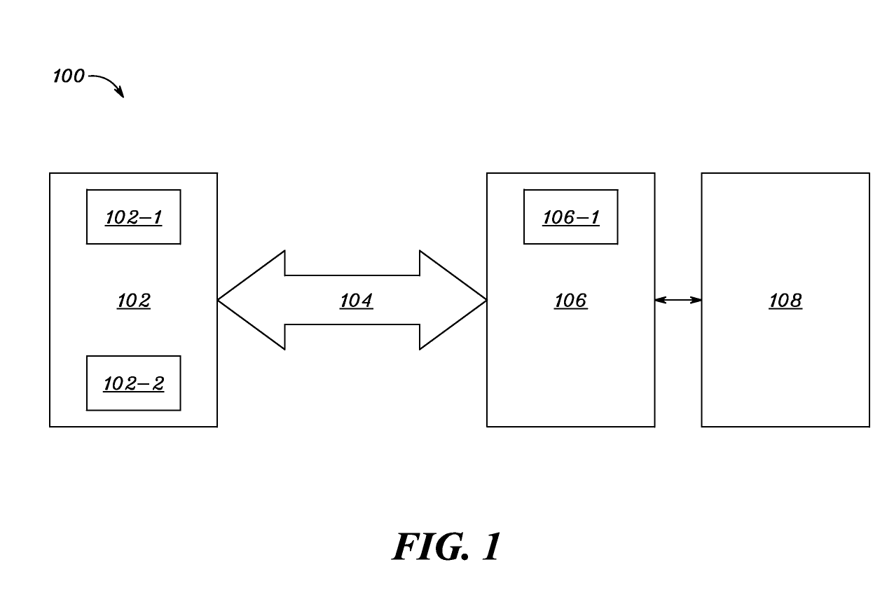

FIG. 1 is a block diagram illustrating a system 100 for testing mobility devices in accordance with the present disclosure. The system 100 includes a mobility device 102, a communication protocol 104, a test framework 106, and a test system 108. The mobility device 102 includes a server application 102-1, and an operating system 102-2. On the other hand, the test framework 106 includes a client application 106-1. In the system 100, the test framework 106 is communicatively coupled with the mobility device 102 over the communication protocol 104.

The mobility device 102 refers to a moving device that requires testing in real time, and is located at a remote location. The mobility device 102 includes a network interface (not shown), a display unit (not shown), a memory (not shown), and a processor (not shown). Further, the mobility device 102 includes the operating system 102-2 that is capable of managing various subsystems present in the mobility device 102. Examples of the various subsystems include, but not limited to, an electronic control module, a temperature sensor, a fuel tank sensor, etc. In an embodiment, the mobility device 102 may be a separate physical entity communicatively coupled with one or more other devices. Examples of the one or more other devices may include, but not limited to, a hydraulic excavator, a motor grader, a dozer, a haul truck, or an articulated truck. It should be noted that the above-mentioned examples of the one or more other devices have been provided only for illustration purposes. In another embodiment, the mobility device 102 may be a standalone device that is to be tested. In an embodiment, the mobility device 102 may include, but not limited to, a mobile phone, a laptop, or a PDA. In an embodiment, the mobility device 102 is located at a geographically remote location from the test framework 106, for example, in two different continents. In order to be remotely tested, the mobility device 102 is not required to be located within, or in close proximity of, a service station or any mobile test site, thus, the embodiments of the present disclosure enable real time testing of the mobility device 102, located at the remote location (i.e., outside the service station or the mobile test site).

The mobility device 102 is communicatively coupled with the test framework 106 by the communication protocol 104 such as, but not limited to, a TCP/IP protocol or a User Datagram Protocol (UDP). Further, the mobility device 102 is configured to execute the server application 102-1. The server application 102-1 receives a request from the client application 106-1 running on the test framework 106 for establishing a communication using the communication protocol 104. In response to the received request for the communication, the server application 102-1 sends an acknowledgement message in order to establish a communication channel between the client application 106-1 and the server application 102-1.

Once the communication is established, the server application 102-1 receives a remote command, over the communication protocol 104, from the client application 106-1, for retrieving a test information. Based on the received remote command, the server application 102-1 communicates with the operating system 102-2 of the mobility device 102 in order to generate the test information. In an embodiment, the test information includes, but not limited to, information related to the operating system 102-2 such as a CPU usage, a memory usage, a process count, etc, or an information related to the server application 102-1. In another embodiment, the test information may include information such as logging information, trace messages, or specific parameters of the server application 102-1 etc. In an alternative embodiment, the test information may include a screenshot of a region of interest area that is displayed on the display unit of the mobility device 102. It will be apparent to one skilled in the art that the above-mentioned test information has been provided only for illustration purposes, and should not limit the scope of the disclosure to these test information only.

After generating the test information, the server application 102-1 running on the mobility device 102 compresses the test information by using a custom compressor in order to reduce the size of the test information. The test information is compressed by using one or more compression techniques, known in the art. Thereafter, the server application 102-1 sends the compressed test information to the client application 106-1 running on the test framework 106 by using the communication protocol 104. The test framework 106 then sends the test information to the test system 108 for performing one or more tests of the mobility device 102.

The test framework 106 is communicatively coupled with the mobility device 102 by the communication protocol 104 such as, but not limited to, the TCP/IP protocol or the UDP protocol. As discussed above, the client application 106-1 running on the test framework 106 sends a request to the server application 102-1 for establishing communication using the communication protocol 104. In response to the request for communication, the client application 106-1 receives an acknowledgement message from the server application 102-1 running on the mobility device 102 in order to establish the communication channel between the client application 106-1 and the server application 102-1. Once the communication is established, the client application 106-1 sends the remote command, over the communication protocol 104, to the server application 102-1 for retrieving the test information. As discussed above, the test information may include, but not limited to, the information related to the operating system 102-2, the information related to the server application 102-1, and the screenshot of the region of interest area on the display unit of the mobility device 102. It will be apparent to one skilled in the art that the above-mentioned test information has been provided only for illustration purposes, and should not limit the scope of the disclosure to these test information only.

After sending the remote command, the client application 106-1 running on the test framework 106 receives the compressed test information from the server application 102-1 over the communication protocol 104. Thereafter, the compressed test information is decompressed by using one or more decompression techniques. Once the compressed test information is decompressed, the test framework 106 sends the test information to the test system 108. The test system 108 performs the one or more tests of the mobility device 102 based on the test information received from the test framework 106. Thus, the test system 108 performs automated real time testing of the mobility device 102 located at the remote location based on the received real time test information from the test framework 106. In an embodiment, the test framework 106 and the test system 108 are integrated into a single computing device such as, but not limited to, a computer, a laptop, a mobile phone etc.

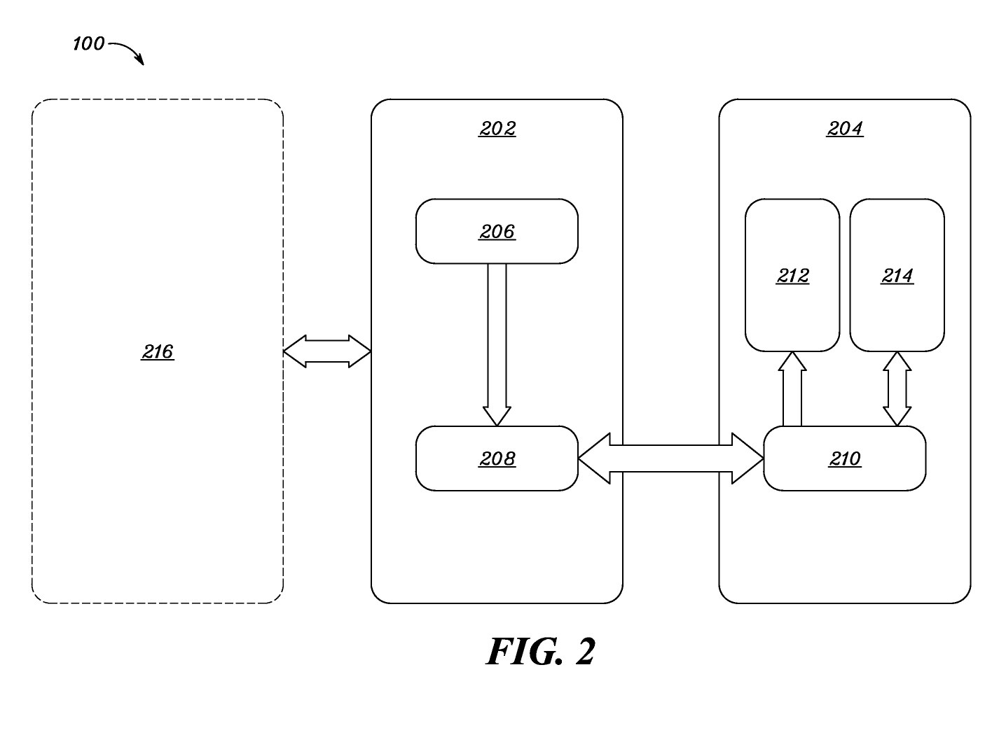

FIG. 2 is a schematic diagram illustrating the system 100 for performing real time testing of the mobility device 102 located at the remote location in accordance with the present disclosure. The system 100 further includes a RemCom.exe 202, a DevCom.exe 204, and languages 216. The RemCom.exe 202 includes a data synchronization application 206, and a communication socket-1 208. On the other hand, the DevCom.exe 204 includes a communication socket-2 210, key and mouse commands 212, and a screen capture module 214. The system 100 is described in detail in conjunction with FIG. 1.

The RemCom.exe 202 is the client application 106-1 running on the test framework 106, which sends the request to the DevCom.exe 204 (the server application 102-1) running on the mobility device 102 for establishing the communication using the communication socket-1 208 such as a TCP/IP socket. In response to the request for the communication, the DevCom.exe 204 sends an acknowledgement message in order to establish the communication channel between the RemCom.exe 202 and the DevCom.exe 204. In an embodiment, the communication socket-1 208 is configured to establish and maintain a physical link layer with the communication socket-2 210 of the DevCom.exe 204.

Once the communication channel is established, the RemCom.exe 202 sends the remote command to the DevCom.exe 204, over the communication socket-1 208, for retrieving the test information. In an embodiment, the RemCom.exe 202 includes the data synchronization application 206 that is configured to synchronize data transfer between the RemCom.exe 202 and the DevCom.exe 204. The data synchronization application 206 may be an ActiveSync™ application. Further, the key and mouse commands 212 of the DevCom.exe 204 are utilized for decoding the remote command received from the RemCom.exe 202.

In response to the received remote command, the screen capture module 214 is configured to retrieve the test information by communicating with the operating system 102-2 of the mobility device 102. As discussed above, the test information may include, but not limited to, the information related to the operating system 102-2, the information related to the server application 102-1, and a screenshot of the region of interest area on the display unit of the mobility device 102.

After retrieving the test information, the DevCom.exe 204 compresses the test information by using the custom compressor in order to reduce the size of the test information. Further, the DevCom.exe 204 sends the compressed test information to the RemCom.exe 202 by using the communication socket-2 210. Thereafter, the compressed test information is decompressed by using the one or more decompression techniques. Once the compressed test information is decompressed, the test framework 106 sends the test information to the test system 108 (not shown). The test system 108 performs real time testing of the mobility device 102 located at the remote location based on the received real time information.

In an embodiment, the RemCom.exe 202 is executed by the testing framework 106, and is configured to support the languages 216 such as high-level languages, and scripting languages. The high level languages may include, but not limited to, C, C++, Java, C# etc. On the other hand, the scripting languages may include, but not limited to, VBA, JavaScript, CVI, or Python. The languages 216 enable the RemCom.exe 202 to be accessed easily by means of any programming language. In an embodiment, the RemCom.exe 202 may be provided as an installed application in the test framework 106 or an online application that is accessed by using a web browser.

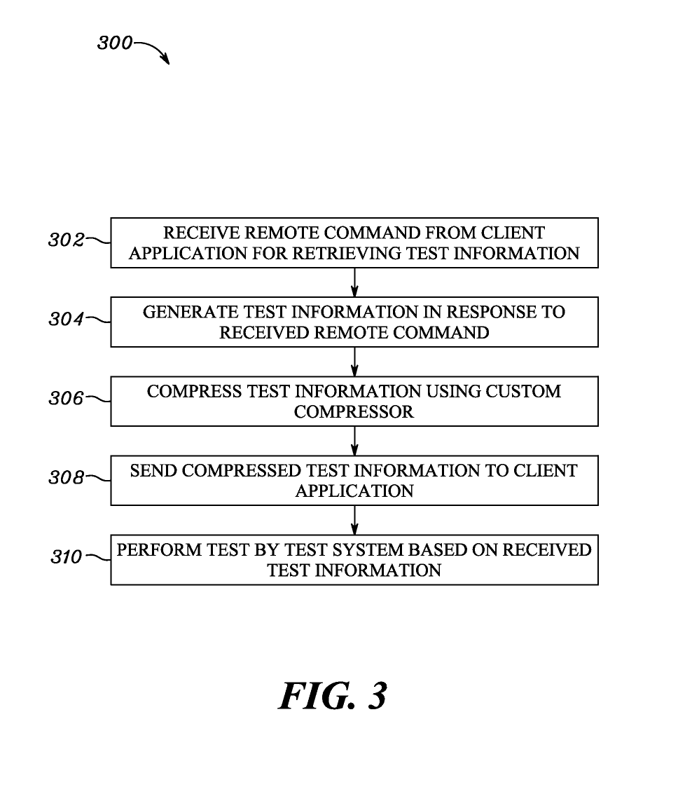

FIG. 3 is a flowchart illustrating a method 300 for performing real time testing of the mobility device 102 located at the remote location in accordance with the present disclosure. The method 300 has been described in conjunction with FIG. 1, and FIG. 2.

At step 302, a remote command is received from the client application 106-1 running on the test framework 106, over the communication protocol 104, by the server application 102-1 running on the mobility device 102, for retrieving the test information. Prior to receiving the remote command from the client application 106-1, the server application 102-1 receives a request from the client application 106-1 for establishing communication using the communication protocol 104. In response to the received request for the communication, the server application 102-1 sends an acknowledgement message in order to establish a communication channel between the client application 106-1 and the server application 102-1. Once the communication channel is established, the server application 102-1 receives the remote command from the client application 106-1 for retrieving the test information. As discussed above, the communication protocol 104 may be the TCP/IP protocol, or the UDP protocol.

At step 304, the test information is generated by the server application 102-1, by communicating with the operating system 102-2 of the mobility device 102, in response to the received remote command. The test information includes, but not limited to, information related to the operating system 102-2 such as the CPU usage, the memory usage, the process count, etc, or the information related to the server application 102-1. In an embodiment, the test information may include information such as logging information, trace messages, or specific parameters of the server application 102-1, etc. In another embodiment, the test information may include a screenshot of the region of interest area that is displayed on the display unit of the mobility device 102. It will be apparent to one skilled in the art that the above-mentioned test information has been provided only for illustration purposes, and should not limit the scope of the disclosure to these test information only.

At step 306, the test information is compressed by using the custom compressor running on the mobility device 102. In an embodiment, the test information is compressed by using the one or more compression techniques in order to reduce the size of the test information. For example, if the size of the test information is 50 MB, then the test information may be compressed to 20 MB in order to reduce the size of the test information by using the one or more compression techniques. At step 308, the compressed test information is sent to the client application 106-1 running on the test framework 106 over the communication protocol 104.

At step 310, one or more tests are performed by the test system 108 based on the test information. Prior to performing the one or more tests, the test system 108 is configured to receive the test information from the test framework 106. The test information is retrieved from the compressed test information by using the one or more decompression techniques. Thereafter, the test system 108 performs the one or more tests of the mobility device 102 that is in motion, and is located at the remote location in real time based on the received real time information from the test framework 106. In an embodiment, the test system 108 and the test framework 106 are integrated into a single computing device such as a computer, a laptop, a mobile phone etc.

For example, a user, using the test system 108, tests air pressure in the tires of the truck. The user may provide a command to establish a communication channel with the server application 102-1 running on the mobility device 102 (e.g., a hydraulic excavator) using the communication protocol 104 such as the TCP/IP protocol, or the UDP protocol. Once the communication channel is established, the user enters the remote command by entering a particular number or a set of predefined numbers through the client application 106-1 running on the test framework 106. The set of predefined numbers correspond to the air pressure in the tires of the hydraulic excavator. In an embodiment, the user may click a button on a User Interface of the test framework 106, in order to enter the remote command.

Based on the received remote command, the server application 102-1 running on the mobility device 102 (e.g., the hydraulic excavator) decodes the remote command for retrieving the required information of the air pressure in the tires of the truck. Thereafter, a screenshot module captures the air pressure information that is displayed on a display unit (not shown) of the mobility device 102 (e.g., the hydraulic excavator). The screenshot module may capture the screenshot by accessing a display buffer of the display unit. The captured screenshot is further compressed by using the custom compressor, and sent to the client application 106-1 running on the test framework 106 over the communication protocol 104 for real time testing of the mobility device 102 (e.g., the hydraulic excavator). Thereafter, the user may perform one or more tests of the mobility device 102 using the test system 108.

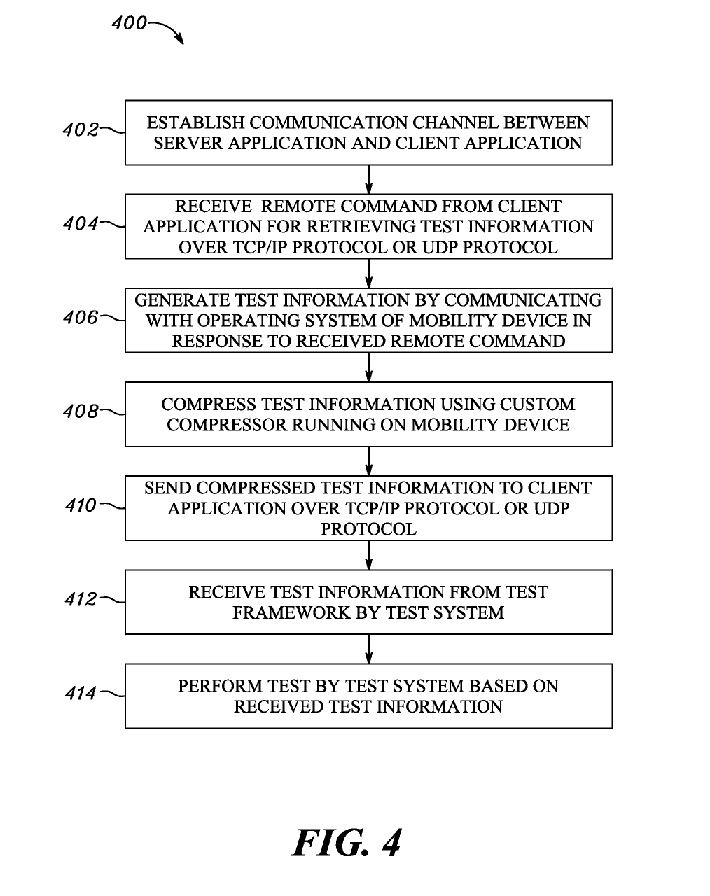

FIG. 4 is a detailed flowchart illustrating a method 400 for performing real time testing of the mobility device 102 located at the remote location using the test framework 106 communicatively coupled with the mobility device 102 by means of either the TCP/IP protocol or the UDP protocol in accordance with an embodiment of the present disclosure. The method 400 has been described in conjunction with FIG. 1, FIG. 2, and FIG. 3.

At step 402, a communication channel is established between the server application 102-1 and the client application 106-1. As discussed above, the server application 102-1 is running on the mobility device 102, and the client application 106-1 is running on the test framework 106. Prior to establishing the communication, the server application 102-1 receives the request from the client application 106-1 for establishing the communication using the communication protocol 104. In response to the received request for communication, the server application 102-1 sends an acknowledgement message in order to establish the communication channel between the client application 106-1 and the server application 102-1. Thereafter, the communication is established between the server application 102-1 and the client application 106-1.

At step 404, the remote command is received from the client application 106-1, by the server application 102-1, for retrieving the test information. The remote command is received over the communication protocol 104. In an embodiment, the remote command may be in the form of a predefined number sequence.

At step 406, the test information is generated by the server application 102-1, by communicating with the operating system 102-2 of the mobility device 102, in response to the received remote command. As discussed above, the test information includes, but not limited to, information related to the operating system 102-2, information related to the server application 102-1, or screenshot of the region of interest area on the display unit (not shown) of the mobility device 102.

At step 408, the test information is compressed by using a custom compressor running on the mobility device 102. In an embodiment, the test information is compressed by using the one or more compression techniques in order to reduce the size of the test information. At step 410, the compressed test information is sent to the client application 106-1 running on the test framework 106 over the communication protocol 104.

At step 412, the test information is received from the test framework 106, by the test system 108. Prior to receiving the test information, the test framework 106 decompresses the compressed test information into the test information by using the one or more decompression techniques. Thereafter, the test framework 106 sends the test information to the test system 108. In another embodiment, the test framework 106 may send the test information in compressed form, and the test information is decompressed by the test system 108.

At step 414, one or more tests are performed by the test system 108 based on the test information. The one or more tests are performed for real time testing of the mobility device 102 that is in motion, and is located at the remote location in response to real time information received from the test framework 106. In an embodiment, the test system 108 and the test framework 106 are integrated into a single computing device such as a computer, a laptop, a mobile phone etc.

### INDUSTRIAL APPLICABILITY

Testing of devices such as electronic devices, and electromechanical devices having a plurality of sophisticated subsystems is well known. A device that is physically located within or near a service station can be physically tested as well as directly connected to the test system by means of plug-in cables for testing. In certain situations, mobile sites are created such that a device to be tested is required to be in the close proximity of the mobile site for transferring test data. Moreover, the device to be tested is usually stopped from performing its usual functions, and is required to be involved in the testing process only.

Devices that are on the move and are located in remote geographic locations can neither access a service station nor a mobile site, and therefore, cannot be connected to the test system for providing real time test information. Moreover, the test system requires test information from the multiple sources for conducting a test, this process of compiling and analyzing test information can be time consuming and may introduce errors into the testing and reporting procedure. Testing a device is also dependent on the operating system of the device such that for a particular operating system, a particular test system is needed. This further complicates testing due to non-interoperability of the test system for different devices having different operating systems.

FIG. 3 is a flowchart illustrating the method 300 for performing real time testing of the mobility device 102 located at the remote location in accordance with the present disclosure. At step 302, the remote command is received from the client application 106-1 running on the test framework 106, over the communication protocol 104, by the server application 102-1 running on the mobility device 102, for retrieving the test information. Prior to receiving the remote command from the client application 106-1, the server application 102-1 receives a request from the client application 106-1 for establishing communication using the communication protocol 104. In response to the received request for the communication, the server application 102-1 sends an acknowledgement message in order to establish a communication channel between the client application 106-1 and the server application 102-1. Once the communication channel is established, the server application 102-1 receives the remote command from the client application 106-1 for retrieving the test information. As discussed above, the communication protocol 104 may be the TCP/IP protocol, or the UDP protocol.

At step 304, the test information is generated by the server application 102-1, by communicating with the operating system 102-2 of the mobility device 102, in response to the received remote command. The test information includes, but not limited to, information related to the operating system 102-2 such as the CPU usage, the memory usage, the process count, etc, or the information related to the server application 102-1. In an embodiment, the test information may include information such as logging information, trace messages, or specific parameters of the server application 102-1, etc. In another embodiment, the test information may include a screenshot of the region of interest area that is displayed on the display unit of the mobility device 102. It will be apparent to one skilled in the art that the above-mentioned test information has been provided only for illustration purposes, and should not limit the scope of the disclosure to these test information only.

At step 306, the test information is compressed by using the custom compressor running on the mobility device 102. In an embodiment, the test information is compressed by using the one or more compression techniques in order to reduce the size of the test information. For example, if the size of the test information is 50 MB, then the test information may be compressed to 20 MB in order to reduce the size of the test information by using the one or more compression techniques. At step 308, the compressed test information is sent to the client application 106-1 running on the test framework 106 over the communication protocol 104.

At step 310, one or more tests are performed by the test system 108 based on the test information. Prior to performing the one or more tests, the test system 108 is configured to receive the test information from the test framework 106. The test information is retrieved from the compressed test information by using the one or more decompression techniques. Thereafter, the test system 108 performs the one or more tests of the mobility device 102 that is in motion, and is located at the remote location in real time based on the received real time information from the test framework 106. In an embodiment, the test system 108 and the test framework 106 are integrated into a single computing device such as a computer, a laptop, a mobile phone etc.

For example, a user, using the test system 108, tests air pressure in the tires of the truck. The user may provide a command to establish a communication channel with the server application 102-1 running on the mobility device 102 (e.g., a hydraulic excavator) using the communication protocol 104 such as the TCP/IP protocol, or the UDP protocol. Once the communication channel is established, the user enters the remote command by entering a particular number or a set of predefined numbers through the client application 106-1 running on the test framework 106. The set of predefined numbers correspond to the air pressure in the tires of the hydraulic excavator. In an embodiment, the user may click a button on a User Interface of the test framework 106, in order to enter the remote command.

Based on the received remote command, the server application 102-1 running on the mobility device 102 (e.g., the hydraulic excavator) decodes the remote command for retrieving the required information of the air pressure in the tires of the truck. Thereafter, a screenshot module captures the air pressure information that is displayed on a display unit (not shown) of the mobility device 102 (e.g., the hydraulic excavator). The screenshot module may capture the screenshot by accessing a display buffer of the display unit. The captured screenshot is further compressed by using the custom compressor, and sent to the client application 106-1 running on the test framework 106 over the communication protocol 104 for real time testing of the mobility device 102 (e.g., the hydraulic excavator). Thereafter, the user may perform one or more tests of the mobility device 102 using the test system 108. Thus, the method for real time testing of the mobility device 102, enables real time testing of the mobility device 102 located at a remote location. The method also eliminates the need for the mobility device 102 to be in close proximity of a service station or a mobile site. The method also increases the interoperability of the test system 108 for different devices having different operating systems. Also, the tests may be performed in real time, eliminating the need for stopping the mobility device 102 from performing its usual functions during the testing, for example, the method enables testing of an articulated truck (i.e. the mobility device 102) which is moving on a highway transporting excavated material.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for performing a real time testing of a mobility device located at a remote location using a test framework communicatively coupled with the mobility device by means of either a TCP/IP protocol or a UDP protocol, and configured to execute a client application, the method comprising:
receiving a remote command from the client application, by a server application running on the mobility device, for retrieving a test information, wherein the remote command is received over either the TCP/IP protocol or the UDP protocol;
generating, by the server application, the test information by communicating with an operating system of the mobility device, in response to the received remote command, wherein the test information comprises at least one of an information related to the operating system, an information related to the server application, and a screenshot of a region of interest area on a display unit of the mobility device;
compressing the test information using a custom compressor running on the mobility device;
sending, by the server application, the compressed test information to the client application, wherein the compressed test information is sent over either the TCP/IP protocol or the UDP protocol; and
performing at least one test, by a test system, based on the test information, wherein the test system is configured to receive the test information from the test framework.
